(19) United States
(12) Patent Application Publication
(10) Pub. No.: US 2021/0334992 A1
(43) Pub. Date: Oct. 28, 2021

(54) SENSOR-BASED DEPTH ESTIMATION

(71) Applicant: Apple Inc., Cupertino, CA (US)

(72) Inventor: Walter Nistico, Redwood City, CA (US)

(21) Appl. No.: 17/236,129

(22) Filed: Apr. 21, 2021

Related U.S. Application Data
(60) Provisional application No. 63/013,647, filed on Apr. 22, 2020.

(51) Int. Cl. G06T 7/521; H04N 5/225

(52) U.S. Cl. CPC G06T 7/521; G06T 2207/10028; G06T 2207/10152; H04N 5/2256

(57) ABSTRACT

Various implementations disclosed herein include techniques for estimating depth using sensor data indicative of changes in light intensity. In one implementation a method includes acquiring pixel events output by an event sensor that correspond to a scene disposed within a field of view of the event sensor. Each respective pixel event is generated in response to a specific pixel sensor within a pixel array of the event sensor detecting a change in light intensity that exceeds a comparator threshold. Mapping data is generated by correlating the pixel events with multiple illumination patterns projected by an optical system towards the scene. Depth data is determined for the scene relative to a reference position based on the mapping data.

### CROSS-REFERENCE TO RELATED APPLICATION

This application claims the benefit of U.S. Provisional Application Ser. No. 63/013,647 filed Apr. 22, 2020, which is incorporated herein in its entirety.

### TECHNICAL FIELD

The present disclosure generally relates to machine vision, and in particular, to techniques for estimating depth using structured light.

### BACKGROUND

Various image-based techniques exist for estimating depth information for a scene by projecting light onto the scene. For example, structured light depth estimation techniques involve projecting a known light pattern onto a scene and processing image data of the scene to determine depth information based on the known light pattern. In general, such image data is obtained from one or more conventional frame-based cameras. The high resolution typically offered by such frame-based cameras facilitates spatially dense depth estimates. However, obtaining and processing such images for depth estimation may require a substantial amount of power and result in substantial latency.

### SUMMARY

Various implementations disclosed herein relate to techniques for estimating depth information using structured light. In one implementation, a method includes acquiring pixel events output by an event sensor that correspond to a scene disposed within a field of view of the event sensor. Each respective pixel event is generated in response to a specific pixel sensor within a pixel array of the event sensor detecting a change in light intensity that exceeds a comparator threshold. Mapping data is generated by correlating the pixel events with multiple illumination patterns projected by an optical system towards the scene. Depth data is determined for the scene relative to a reference position based on the mapping data.

In one implementation, another method includes acquiring pixel events output by an event sensor that correspond to a scene disposed within a field of view of the event sensor. Each respective pixel event is generated in response to a specific pixel sensor within a pixel array of the event sensor detecting a change in light intensity that exceeds a comparator threshold. Mapping data is generated by correlating the pixel events with multiple frequencies projected by an optical system towards the scene. Depth data is determined for the scene relative to a reference position based on the mapping data.

In accordance with some implementations, a non-transitory computer readable storage medium has stored therein instructions that are computer-executable to perform or cause performance of any of the methods described herein. In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations

FIG. 2 is a block diagram of pixel sensors for an event camera and an example circuit diagram of a pixel sensor, in accordance with some implementations.

FIG. 3 illustrates an example of projecting multiple illumination patterns in a time-multiplexing manner, in accordance with some implementations.

FIG. 4 illustrates an example of forming multiple illumination patterns by spatially shifting each pattern element of a single illumination pattern by different pre-defined spatial offsets, in accordance with some implementations.

FIG. 5 illustrates an example of an illumination pattern, in accordance with some implementations.

FIG. 6 illustrates another example illumination pattern that forms a complementary pair with the example illumination pattern of FIG. 5.

FIG. 7 illustrates an example of projecting a single illumination pattern onto a projection plane.

FIG. 8 illustrates an example projecting multiple illumination patterns in a time-multiplexed manner onto the projection plane of FIG. 7.

FIG. 9 illustrates an example of extending a maximum depth estimation range without increasing the power consumption of an optical system.

FIG. 10 illustrates an example of encoding multiple illumination patterns with different modulating frequencies.

FIG. 11 illustrates another example of encoding multiple illumination patterns with different modulating frequencies.

FIG. 12 is a flowchart illustrating an example of a method for estimating depth using sensor data indicative of changes in light intensity.

FIG. 13 is a flowchart illustrating another example of a method for estimating depth using sensor data indicative of changes in light intensity.

FIG. 14 is a block diagram of an example electronic device, in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

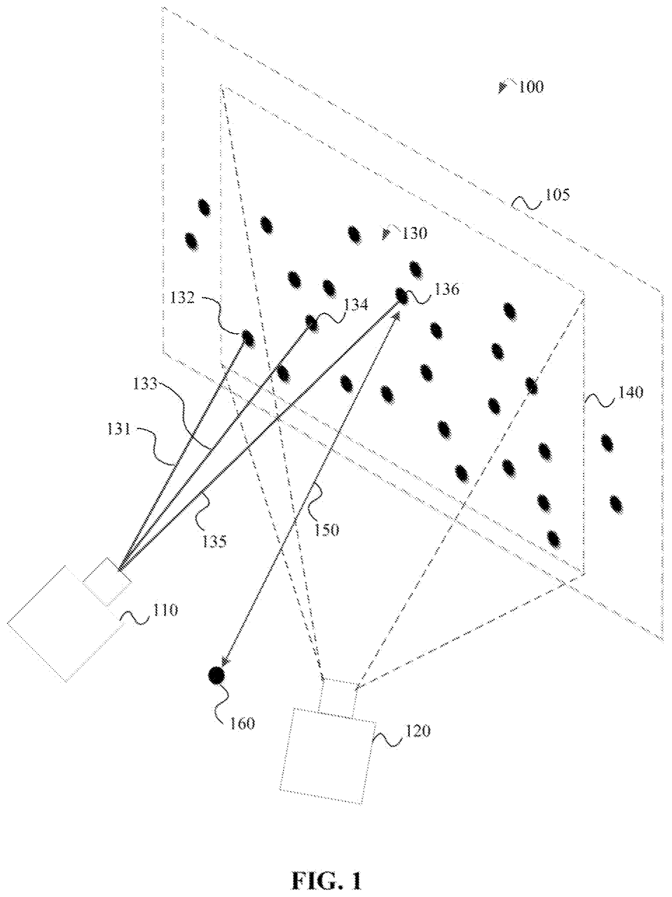

Referring to FIG. 1, an example operating environment 100 for implementing aspects of the present invention is illustrated and designated generally 100. As depicted in the example of FIG. 1, operating environment 100 includes an optical system 110 and an image sensor system 120. In general, operating environment 100 represents the various devices involved in generating depth data for a scene 105 using structured light techniques. To that end, optical system 110 is configured to project or emit a known pattern of light (“illumination pattern”) 130 onto scene 105. In FIG. 1, illumination pattern 130 is projected onto scene 105 using a plurality of optical rays or beams (e.g. optical rays 131, 133, and 135) that each form a particular pattern element of illumination pattern 130. For example, optical ray 131 forms pattern element 132, optical ray 133 forms pattern element 134, and optical ray 135 forms pattern element 136.

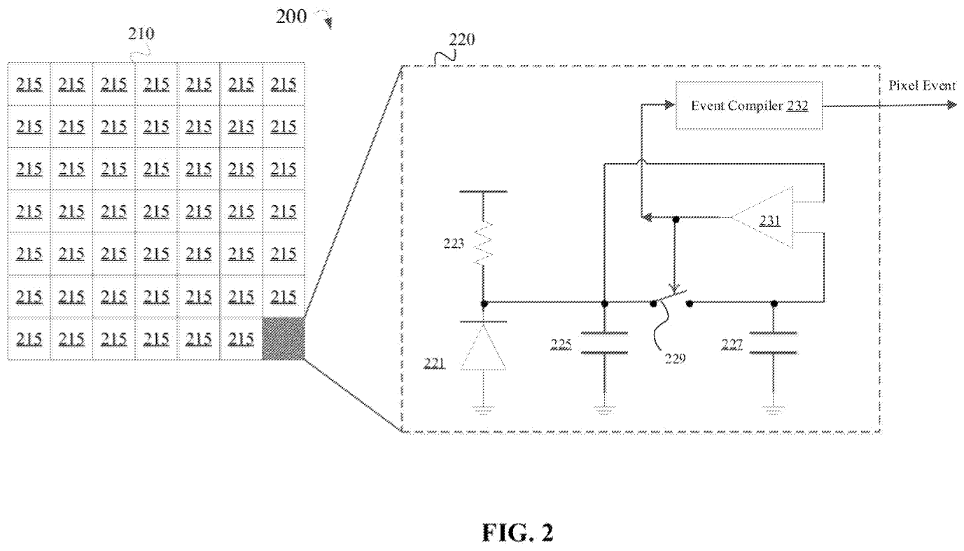

Image sensor system 120 is configured to generate sensor data indicative of light intensity associated with a portion of scene 105 disposed within a field of view 140 of image sensor system 120. In various implementations, at least a subset of that sensor data is obtained from a stream of pixel events output by an event sensor (e.g. event sensor 200 of FIG. 2). As described in greater detail below, pixel events output by an event sensor are used to determine depth data for scene 105 relative to a reference position 160. Such depth data may include depth information (e.g., depth 150) for each pattern element of illumination pattern 130 within field of view 140 that is determined by searching for correspondences between the pixel events and each pattern element. In one implementation, one or more optical filters may be disposed between image sensor system 120 and scene 105 to partition ambient light from light emitted by optical system 110. In an implementation, reference position 160 is defined based on: an orientation of optical system 110 relative to image sensor system 120, a location of optical system 110 relative to image sensor system 120, or a combination thereof.

In an implementation, optical system 110 comprises a plurality of optical sources and each optical ray is emitted by a different optical source. In an implementation, optical system 110 comprises a single optical source and the plurality of optical rays are formed using one or more optical elements, including: a mirror, a prism, a lens, an optical waveguide, a diffractive structure, and the like. In an implementation, optical system 110 comprises a number of optical sources that both exceeds one and is less than a total number of optical rays forming a given illumination pattern. For example, if the given illumination pattern is formed using four optical rays, optical system 110 may comprise two or three optical sources. In this implementation, at least one optical ray of the plurality of optical rays is formed using one or more optical elements. In one implementation, optical system 110 comprises: an optical source to emit light in a visible wavelength range, an optical source to emit light in a near-infrared wavelength range, an optical source to emit light in an ultra-violet wavelength range, or a combination thereof.

FIG. 2 is a block diagram of pixel sensors 215 for an example event sensor 200 or dynamic vision sensor (DVS) and an example circuit diagram 220 of a pixel sensor, in accordance with some implementations. As illustrated by FIG. 2, pixel sensors 215 may be disposed on event sensor 200 at known locations relative to an electronic device (e.g., optical system 110 of FIG. 1 and/or electronic device 1500 of FIG. 15) by arranging the pixel sensors 215 in a two-dimensional (“2D”) matrix 210 of rows and columns. In the example of FIG. 2, each of the pixel sensors 215 is associated with an address identifier defined by one row value and one column value that uniquely identifies a particular location within the 2D matrix.

FIG. 2 also shows an example circuit diagram of a circuit 220 that is suitable for implementing a pixel sensor 215. In the example of FIG. 2, circuit 220 includes photodiode 221, resistor 223, capacitor 225, capacitor 227, switch 229, comparator 231, and event compiler 232. In operation, a voltage develops across photodiode 221 that is proportional to an intensity of light incident on the pixel sensor 215. Capacitor 225 is in parallel with photodiode 221, and consequently a voltage across capacitor 225 is the same as the voltage across photodiode 221.

In circuit 220, switch 229 intervenes between capacitor 225 and capacitor 227. Therefore, when switch 229 is in a closed position, a voltage across capacitor 227 is the same as the voltage across capacitor 225 and photodiode 221. When switch 229 is in an open position, a voltage across capacitor 227 is fixed at a previous voltage across capacitor 227 when switch 229 was last in a closed position. Comparator 231 receives and compares the voltages across capacitor 225 and capacitor 227 on an input side. If a difference between the voltage across capacitor 225 and the voltage across capacitor 227 exceeds a threshold amount (“a comparator threshold”), an electrical response (e.g., a voltage) indicative of the intensity of light incident on the pixel sensor is present on an output side of comparator 231. Otherwise, no electrical response is present on the output side of comparator 231.

When an electrical response is present on an output side of comparator 231, switch 229 transitions to a closed position and event compiler 232 receives the electrical response. Upon receiving an electrical response, event compiler 232 generates a pixel event and populates the pixel event with information indicative of the electrical response (e.g., a value and/or polarity of the electrical response). In some implementations, pixel events generated by event compiler 332 responsive to receiving an electrical response indicative of a net increase in the intensity of incident illumination exceeding a threshold amount may be referred to as “positive” pixel events with positive polarities. In some implementations, pixel events generated by event compiler 332 responsive to receiving an electrical response indicative of a net decrease in the intensity of incident illumination exceeding a threshold amount may be referred to as “negative” pixel events with negative polarities. In one implementation, event compiler 332 also populates the pixel event with one or more of: timestamp information corresponding to a point in time at which the pixel event was generated and an address identifier corresponding to the particular pixel sensor that generated the pixel event.

An event sensor 200 generally includes a plurality of pixel sensors like pixel sensor 215 that each output a pixel event in response to detecting changes in light intensity that exceed a comparative threshold. Pixel events output by the plurality of pixel sensors form a stream of pixel events output by the event sensor 200. In some implementations, a stream of pixel events including each pixel event generated by event compiler 232 may then be communicated to an image pipeline (e.g. image or video processing circuitry) (not shown) associated with the event sensor 200 for further processing. By way of example, a stream of pixel events generated by event compiler 232 can be accumulated or otherwise combined to produce image data. In some implementations the stream of pixel events is combined to provide an intensity reconstruction image. In this implementation, an intensity reconstruction image generator (not shown) may accumulate pixel events over time to reconstruct and/or estimate absolute intensity values. As additional pixel events are accumulated, the intensity reconstruction image generator changes the corresponding values in the reconstruction image. In this way, it generates and maintains an updated image of values for all pixels of an image even though only some of the pixels may have received events recently.

As discussed above, image data output by a frame-based image sensor provides absolute light intensity at each pixel sensor. In contrast, each pixel event comprising a stream of pixel events output by an event sensor provides sensor data indicative of changes in light intensity at a given pixel sensor. One skilled in the art may appreciate that using such pixel-level sensor data to estimate depth may offer some benefits over estimating depth using image data obtained from frame-based image sensors while mitigating some of the tradeoffs discussed above.

For example, absent from the stream of pixel events is any pixel sensor-level data corresponding to detected changes in light intensity that do not breach the comparative threshold. As such, the stream of pixel events output by the event sensor 200 generally includes sensor data indicative of changes in light intensity corresponding to a subset of pixel sensors as opposed to a larger amount of data regarding absolute intensity at each pixel sensor generally output by frame-based cameras. Therefore, estimating depth using pixel events may involve processing less data than estimating depth using image data output by frame-based image sensors. Consequently, depth estimation techniques based on pixel events may avoid or minimize the increased latency and increased power budget required to process that substantial amount of data output by frame-based image sensors.

As another example, a frame-based image sensor generally outputs image data synchronously based on a frame rate of the sensor. In contrast, each pixel sensor of an event sensor asynchronously emits pixel events responsive to detecting a change in light intensity that exceeds a threshold value, as discussed above. Such asynchronous operation enables the event sensor to output sensor data for depth estimation at a higher temporal resolution than frame-based image sensors. Various implementations of the present disclosure leverage that higher temporal resolution sensor data output by event sensors to generate depth data with increased spatial density.

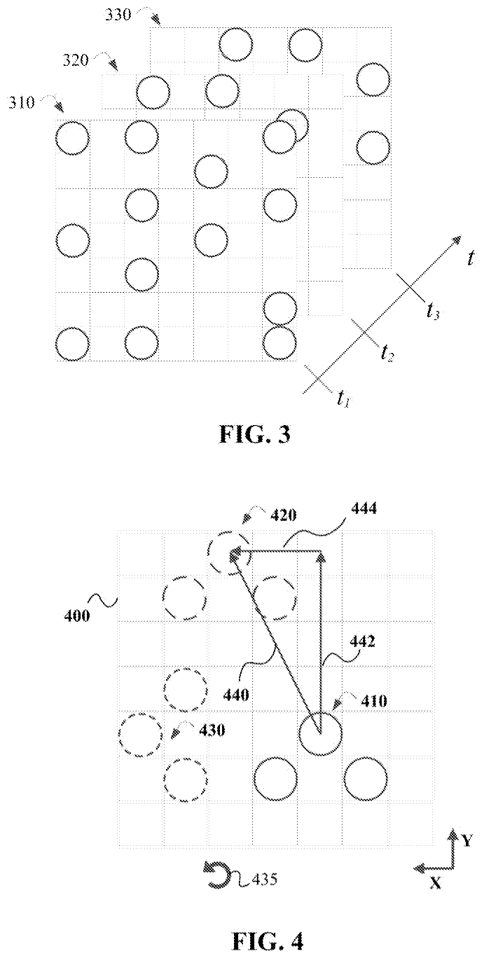

Referring to FIG. 3, one aspect of increasing the spatial density of depth data involves using temporal-multiplexing to sequentially project multiple illumination patterns onto a scene over time. To that end, optical system 110 may be configured to project or emit different illumination patterns over different time periods as illustrated by FIG. 3. For example, during a first time period defined by times t₁ and t₂, optical system 110 may be configured to project illumination pattern 310 onto scene 105. At time t₂, optical system 110 may cease projecting illumination pattern 310 and begin projecting illumination pattern 320 onto scene 105 during a second time period defined by times t₂ and t₃. At time t₃, optical system 110 may cease projecting illumination pattern 320 and begin projecting illumination pattern 330 onto scene 105 during a third time period that commences at time t₃.

Another aspect of increasing that spatial density involves spatially shifting pattern element positions over time to capture or measure depth at different points of a scene. To that end, in some implementations, multiple spatially shifted versions of a single illumination pattern may be projected onto a scene at different times, as illustrated in FIG. 4. Projecting multiple spatially shifted versions of a single illumination pattern onto a scene over time may improve computational efficiency by simplifying pattern decoding operations. Also, projecting different spatially shifted illumination patterns onto a scene at different times may provide additional depth information by repositioning pattern elements around the scene over time thereby increasing the spatial density of depth data.

FIG. 4 depicts three spatially shifted versions of a single illumination pattern comprising three dots positioned in a triangular arrangement that are superimposed onto a common code grid 400. Generally, different versions of the single illumination pattern may be formed by spatially shifting each pattern element of the single illumination pattern by different pre-defined spatial offsets. By way of example, illumination pattern 420 is formed by spatially shifting each pattern element of illumination pattern 410 by pre-defined spatial offset 440. In this example, pre-defined spatial offset 440 includes a vertical offset portion 442 that spatially shifts each pattern element of illumination pattern 410 along a Y-axis of code grid 400 and a horizontal offset portion 444 that spatially shifts each pattern element of illumination pattern 410 along an X-axis of code grid 400. One skilled in the art will appreciate that the vertical offset portion 442 or the horizontal offset portion 444 may be omitted to define another pre-defined spatial offset for forming another spatially shifted version of illumination pattern 410.

Illumination pattern 430 illustrates an example of a pre-defined spatial offset that also includes a rotational offset. In particular, regardless of whether illumination pattern 430 is formed by spatially shifting each pattern element of illumination pattern 410 or 420, the pre-defined spatial offset for forming illumination pattern 430 involves a vertical offset portion and a horizontal offset portion. As shown in FIG. 4, that pre-defined spatial offset further involves rotating the triangular arrangement of pattern elements approximately 90 degrees in a counter clockwise direction 435.

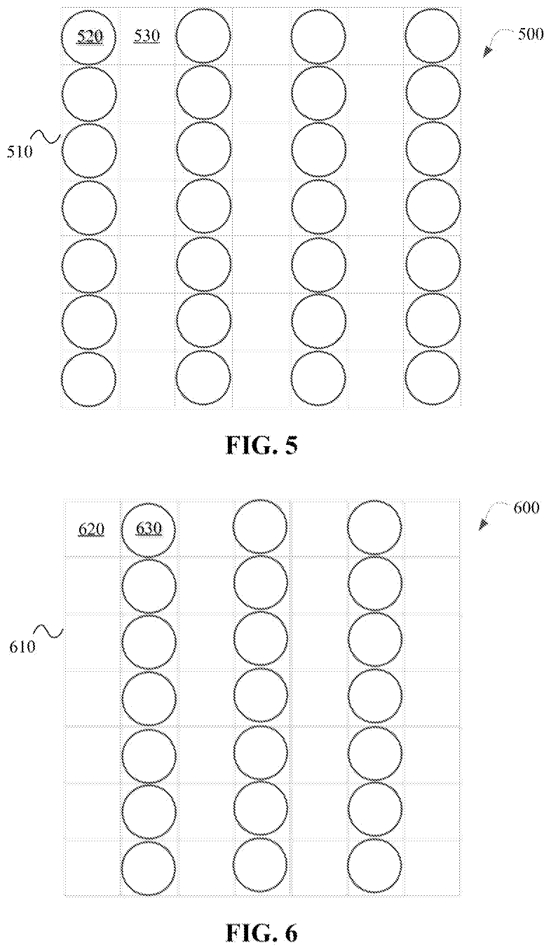

In some implementations, spatially shifting pattern element positions over time to capture or measure depth at different points of a scene may involve projecting a pair of complementary illumination patterns. FIGS. 5 and 6 illustrate an example of a complementary pair formed by illumination pattern 500 and 600. A comparison between FIGS. 5 and 6 illustrates that illumination pattern 600 defines a logical negative of illumination pattern 500 (and vice versa). For example, position 520 of code grid 510 comprises a pattern element whereas a corresponding position (i.e., position 620) of code grid 610 lacks a pattern element. As another example, position 530 of code grid 510 lacks a pattern element whereas a corresponding position (i.e., position 630) of code grid 610 comprises a pattern element.

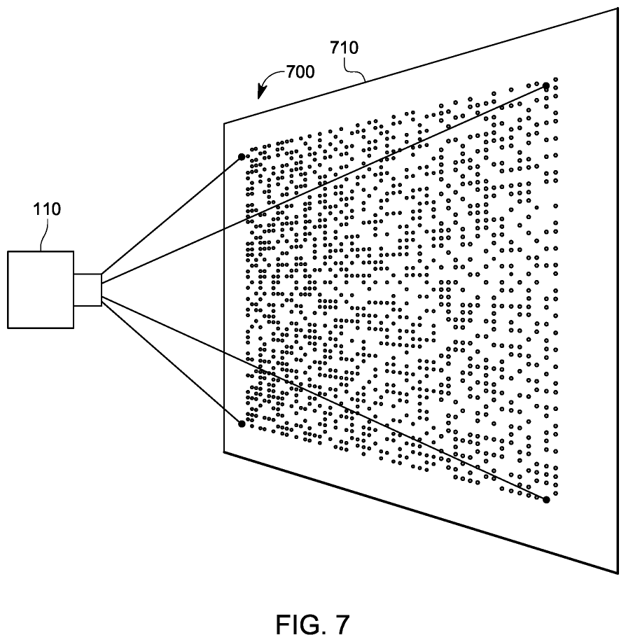

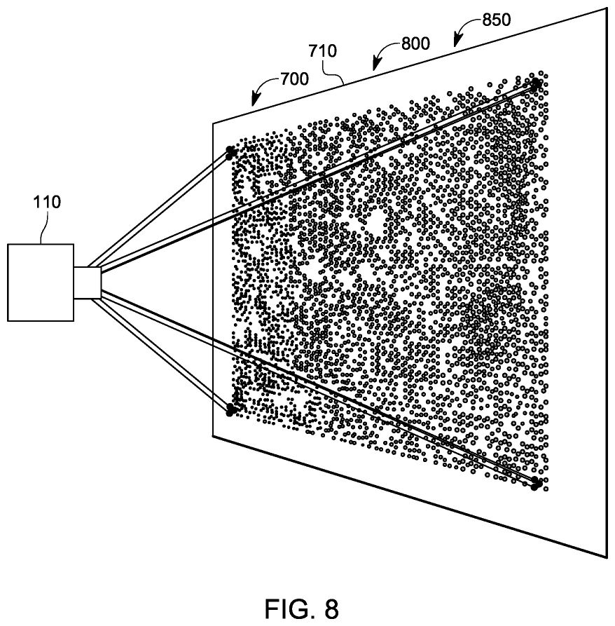

A comparison between FIGS. 7 and 8 illustrates how projecting multiple, spatially shifted illumination patterns in a time-multiplexed manner facilitates generating depth data with increased spatial density. For example, FIG. 7 represents an instance in which optical system 110 is configured to project a single illumination pattern 700 onto projection plane 710. In contrast, FIG. 8 represents an instance in which optical system 110 is configured to project multiple, spatially shifted illumination patterns onto projection plane 710. In the instance represented by FIG. 8, optical system 110 may be configured to project illumination pattern 700 onto projection plane 710 during a first time period. When the first time period concludes, optical system 110 may cease projecting illumination pattern 700 and begin projecting illumination pattern 800 onto projection plane 710 during a second time period. When the second time period concludes, optical system 110 may cease projecting illumination pattern 800 and begin projecting illumination pattern 850 onto projection plane 710 during a third time period.

As illustrated by comparing FIGS. 7 and 8, the density of pattern elements within a given portion of projection plane 710 increases proportional to the increased number of illumination patterns projected onto projection plane 710. To the extent that each additional pattern element provides additional depth information concerning surfaces that intersect with projection plane 710, that increased density of pattern elements facilitates generating depth data with increased spatial density.

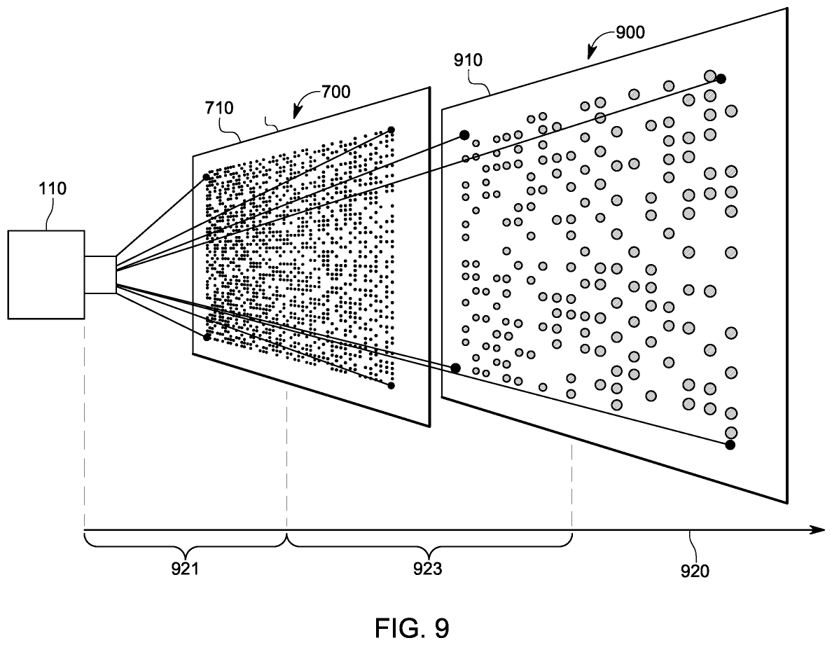

FIG. 9 illustrates an example technique of extending a maximum depth estimation range without increasing the power consumption of optical system 110. In FIG. 9, the multiple illumination patterns that optical system 110 projects in a time-multiplexed manner includes illumination pattern 700 of FIGS. 7-8. As shown by FIG. 9, illumination pattern 700 is configured to project onto projection plane 710 that is located at first distance 921 in a radially outward direction 920 from optical system 110. The multiple illumination patterns that optical system 110 projects in a time-multiplexed manner further includes illumination pattern 900. Illumination pattern 900 is configured to project onto projection plane 910 that is located at a second distance 923 from projection plane 710 in the radially outward direction 920 from optical system 110. That second distance 923 in the radially outward direction 920 represents the extension of the maximum depth estimation range.

To obtain that extension without increasing the power consumption of optical system 110, illumination pattern 900 is formed by distributing the same radiant power used to form illumination pattern 700 among a fewer number of pattern elements. For example, illumination pattern 700 may comprise one thousand pattern elements formed projecting one thousand optical rays from optical system 110 that collectively emit one thousand watts of radiant power. As such, each optical ray forming illumination pattern 700 may emit one watt of radiant power.

Unlike illumination pattern 700, illumination pattern 900 may comprise 100 pattern elements. To avoid increasing the power consumption of optical system 110, the 100 pattern elements of illumination pattern 900 may be formed by projecting 100 optical rays from optical system 110 that collectively emit one thousand watts of radiant power. As such, each optical ray forming illumination pattern 900 may emit 10 watts of radiant power. In doing so, illumination pattern 900 is available for depth estimation purposes at an increased distance from optical system 110. One potential tradeoff for that increased effective distance is the density of pattern elements at projection plane 910 is less than the density of pattern elements at projection plane 710. That decreased density of pattern elements at projection plane 910 may result in generating depth data for surfaces that intersect with projection plane 910 with decreased spatial density.

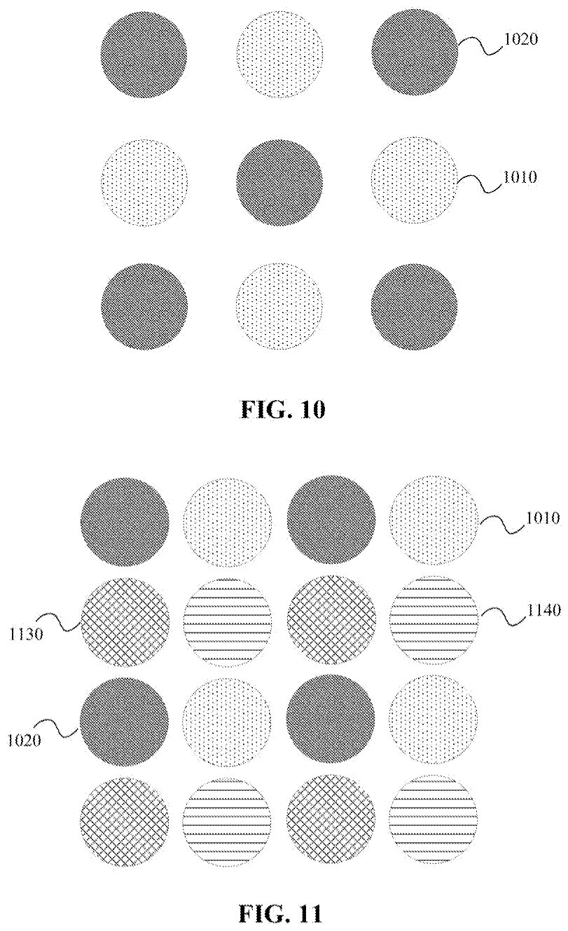

FIGS. 10 and 11 illustrate examples of encoding multiple illumination patterns with different temporal signatures. To that end, each illumination pattern among the multiple illumination patterns is formed by pattern elements that pulse according to a temporal signature. For example, FIG. 10 illustrates two illumination patterns including a first illumination pattern formed by pattern elements 1010 that pulse at a first frequency (e.g., 400 hertz (“Hz”)) and a second illumination pattern formed by pattern elements 1020 that pulse at a second frequency (e.g., 500 Hz).

FIG. 11 illustrates that encoding multiple illumination patterns with different modulating temporal signatures facilitates increasing pattern element density. In particular, FIG. 11 illustrates four illumination patterns including a third illumination pattern formed by pattern elements 1130 that pulse at a third frequency (e.g., 600 Hz) and a fourth illumination pattern formed by pattern elements 1140 that pulse at a fourth frequency (e.g., 700 Hz) in addition to the first and second illumination patterns illustrated in FIG. 10. As shown by FIG. 11, each pattern element of a given illumination pattern is encircled by pattern elements corresponding to different illumination patterns. In doing so, cross-talk between pattern elements of a given illumination pattern is mitigated.

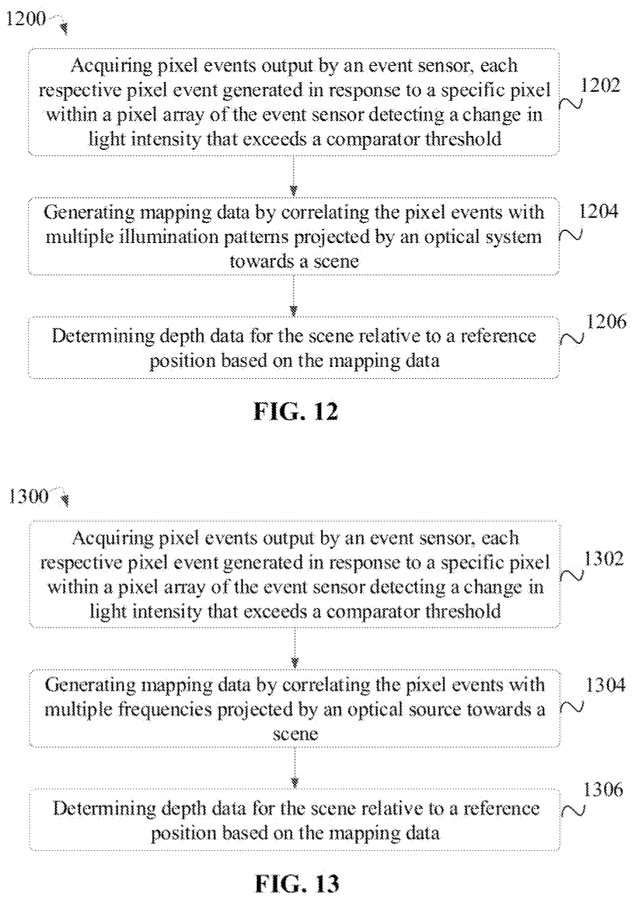

Encoding multiple illumination patterns with different temporal signatures may simplify pattern decoding in as much as reflections of each illumination pattern from a measured surface will produce pixel events at a same frequency as a given modulating frequency encoding that illumination pattern. By way of example, FIG. 12 illustrates an example of an intensity reconstruction image 1210 depicting an eye of a user illuminated with multiple illumination patterns encoded with different modulating frequencies. In this example, image 1210 was derived by an image pipeline from pixel events output by an event sensor with a field of view comprising the eye. As shown by FIG. 12, a portion of FIG. 1210 was formed by pixel events 1250 corresponding to multiple illumination patterns encoded with different modulating frequencies (e.g., the “Projected Dots”). Another portion of FIG. 1210 was formed by pixel events 1240 corresponding to motion artifacts related to movement of the eye (e.g., the “Scene Motion”).

FIG. 12 is a flow-chart illustrating an example of a method 1200 of estimating depth using sensor data indicative of changes in light intensity. At block 1202, method 1200 includes acquiring pixel events output by an event sensor that correspond to a scene disposed within a field of view of the event sensor. Each respective pixel event is generated in response to a specific pixel sensor within a pixel array of the event sensor detecting a change in light intensity that exceeds a comparator threshold.

At block 1204, method 1200 includes generating mapping data by correlating the pixel events with multiple illumination patterns projected by an optical system towards the scene. In one implementation, generating the mapping data comprises searching for correspondences between the pixel events and pattern elements associated with the multiple illumination patterns. In one implementation, generating the mapping data comprises distinguishing between neighboring pattern elements corresponding to different illumination patterns among the multiple illumination patterns using timestamp information associated with the pixel events. An electronic device may execute instructions to generate the mapping data, e.g., via a processor executing instructions stored in a non-transitory computer readable medium.

At block 1206, method 1200 includes determining depth data for the scene relative to a reference position based on the mapping data. In one implementation, the multiple illumination patterns include a first illumination pattern and a second illumination pattern. In one implementation, the mapping data associates a first subset of the pixel events with the first illumination pattern and a second subset of the pixel events with the second illumination pattern. In one implementation, the depth data includes depth information generated at a first time using the pixel events associated with the first illumination pattern and depth information generated at a second time using the pixel events associated with the second illumination pattern. An electronic device may execute instructions to determine the depth data, e.g., via a processor executing instructions stored in a non-transitory computer readable medium.

In one implementation, method 1200 further comprises causing the optical system to increase a number of illumination patterns included among the multiple illumination patterns projected towards the scene. In this implementation, a spatial density of the depth data for the scene is increased proportional to the increased number of illumination patterns. In one implementation, method 1300 further comprises updating the depth data for the scene at a rate that is inversely proportional to a number of illumination patterns included among the multiple illumination patterns.

In one implementation, the multiple illumination patterns include a first illumination pattern (e.g., illumination pattern 410 of FIG. 4) and a second illumination pattern (e.g., illumination patterns 420 and/or 430 of FIG. 4) formed by spatially shifting each element of the first illumination pattern by a pre-defined spatial offset. In one implementation, the multiple illumination patterns include a pair of complementary illumination patterns (e.g., complementary illumination patterns 500 and 600 of FIGS. 5 and 6, respectively) comprising a first illumination pattern and a second illumination pattern defining a logical negative of the first illumination pattern. In one implementation, the multiple illumination patterns have a common radiant power distributed among a different number of pattern elements.

FIG. 13 is a flow-chart illustrating an example of a method 1300 of estimating depth using sensor data indicative of changes in light intensity. At block 1302, method 1300 includes acquiring pixel events output by an event sensor that correspond to a scene disposed within a field of view of the event sensor. Each respective pixel event is generated in response to a specific pixel sensor within a pixel array of the event sensor detecting a change in light intensity that exceeds a comparator threshold.

At block 1304, method 1300 includes generating mapping data by correlating the pixel events with multiple frequencies projected by an optical system towards the scene. In one implementation, generating the mapping data comprises searching for correspondences between the pixel events and pattern elements associated with the multiple frequencies. In one implementation, generating the mapping data comprises evaluating the pixel events to identify successive pixels events having a common polarity that are also associated with a common pixel sensor address. In one implementation, generating the mapping data further comprises determining a temporal signature associated with the successive pixel events by comparing time stamp information corresponding to the successive pixel events. In one implementation, each of the multiple frequencies projected by the optical system encode a different illumination pattern. An electronic device may execute instructions to generate the mapping data, e.g., via a processor executing instructions stored in a non-transitory computer readable medium.

At block 1306, method 1300 includes determining depth data for the scene relative to a reference position based on the mapping data. In one implementation, method 1400 further includes filtering the pixel events prior to generating the mapping data to exclude a subset of the pixel events lacking the multiple frequencies projected by the optical source. An electronic device may execute instructions to determine the depth data, e.g., via a processor executing instructions stored in a non-transitory computer readable medium.

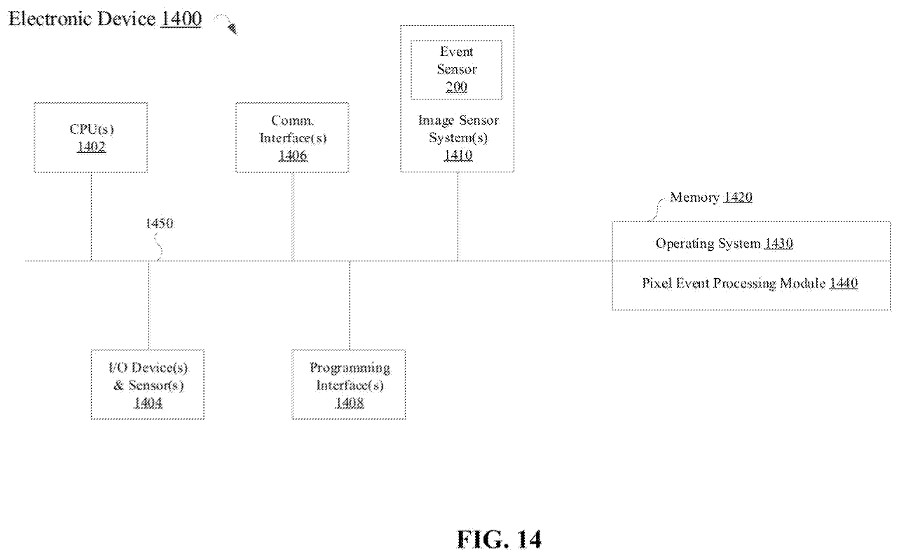

FIG. 14 is a block diagram of an example electronic device 1400 in accordance with some implementations. While certain specific features are illustrated, those skilled in the art will appreciate from the subject matter disclosed herein that various other features have not been illustrated for the sake of brevity, and so as not to obscure more pertinent aspects of the implementations disclosed herein.

To that end, as a non-limiting example, in some implementations electronic device 1400 includes one or more processors 1402 (e.g., microprocessors, ASICs, FPGAs, GPUs, CPUs, processing cores, or the like), one or more I/O devices and sensors 1404, one or more communication interfaces 1406 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, or the like type interface), one or more programming (e.g., I/O) interfaces 1408, one or more image sensor systems 1410, a memory 1420, and one or more communication buses 1450 for interconnecting these and various other components.

In some implementations, the one or more I/O devices and sensors 1404 are configured to provide a human to machine interface exchanging commands, requests, information, data, and the like, between electronic device 1400 and a user. To that end, the one or more I/O devices 1404 can include, but are not limited to, a keyboard, a pointing device, a microphone, a joystick, and the like. In some implementations, the one or more I/O devices and sensors 1404 are configured to detect or measure a physical property of an environment proximate to electronic device 1400. To that end, the one or more I/O devices 1404 can include, but are not limited to, an IMU, an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, and/or the like.

In some implementations, the one or more communication interfaces 1406 can include any device or group of devices suitable for establishing a wired or wireless data or telephone connection to one or more networks. Non-limiting examples the one or more communication interfaces 1406 include a network interface, such as an Ethernet network adapter, a modem, or the like. A device coupled to the one or more communication interfaces 1406 can transmit messages to one or more networks as electronic or optical signals.

In some implementations, the one or more programming (e.g., I/O) interfaces 1408 are configured to communicatively couple the one or more I/O devices 1404 with other components of electronic device 1400. As such, the one or more programming interfaces 1408 are capable of accepting commands or input from a user via the one or more I/O devices 1404 and transmitting the entered input to the one or more processors 1402.

In some implementations, the one or more image sensor systems 1410 are configured to obtain image data that corresponds to at least a portion of a scene local to electronic device 1400. The one or more image sensor systems 1410 can include one or more RGB cameras (e.g., with a complimentary metal-oxide-semiconductor (“CMOS”) image sensor or a charge-coupled device (“CCD”) image sensor), monochrome camera, IR camera, event-based camera, or the like. In various implementations, the one or more image sensor systems 1410 further include optical or illumination sources that emit light, such as a flash. In various implementations, the one or more image sensor systems include event sensor 200.

The memory 1420 can include any suitable computer-readable medium. A computer readable storage medium should not be construed as transitory signals per se (e.g., radio waves or other propagating electromagnetic waves, electromagnetic waves propagating through a transmission media such as a waveguide, or electrical signals transmitted through a wire). For example, the memory 1420 may include high-speed random-access memory, such as DRAM, SRAM, DDR RAM, or other random-access solid-state memory devices. In some implementations, the memory 1420 includes non-volatile memory, such as one or more magnetic disk storage devices, optical disk storage devices, flash memory devices, or other non-volatile solid-state storage devices. The memory 1420 optionally includes one or more storage devices remotely located from the one or more processing units 1402. The memory 1420 comprises a non-transitory computer readable storage medium. Instructions stored in the memory 1420 may be executed by the one or more processors 1402 to perform a variety of methods and operations, including the technique for estimating depth using sensor data indicative of changes in light intensity described in greater detail above.

In some implementations, the memory 1420 or the non-transitory computer readable storage medium of the memory 1420 stores the following programs, modules and data structures, or a subset thereof including an optional operating system 1430 and a pixel event processing module 1440. In some implementations, the pixel event processing module 1440 is configured to process pixel events output by an event driven sensor (e.g., event sensors 200 of FIG. 2) to generate depth data for a scene in accordance with the techniques described above in greater detail. To that end, in various implementations, the pixel event processing module 1440 includes instructions and/or logic therefor, and heuristics and metadata therefor.

FIG. 14 is intended more as functional description of the various features which are present in a particular implementation as opposed to a structural schematic of the implementations described herein. As recognized by those of ordinary skill in the art, items shown separately could be combined and some items could be separated. For example, some functional modules shown separately in FIG. 14 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, or firmware chosen for a particular implementation.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
acquiring pixel events output by an event sensor, each respective pixel event generated in response to a specific pixel sensor within a pixel array of the event sensor detecting a change in light intensity that exceeds a comparator threshold, the pixel events corresponding to a scene disposed within a field of view of the event sensor;
generating mapping data by correlating the pixel events with multiple illumination patterns projected by an optical system towards the scene, wherein the multiple illumination patterns are time-multiplexed; and
determining depth data for the scene relative to a reference position based on the mapping data.

2. The method of claim 1, wherein generating the mapping data comprises:
searching for correspondences between the pixel events and pattern elements associated with the multiple illumination patterns.

3. The method of claim 1, wherein generating the mapping data comprises:
distinguishing between neighboring pattern elements corresponding to different illumination patterns among the multiple illumination patterns using timestamp information associated with the pixel events.

4. The method of claim 1, wherein the multiple illumination patterns include a first illumination pattern and a second illumination pattern, and wherein the mapping data associates a first subset of the pixel events with the first illumination pattern and a second subset of the pixel events with the second illumination pattern.

5. The method of claim 1, wherein the depth data includes depth information generated at a first time using the pixel events associated with a first illumination pattern and depth information generated at a second time using the pixel events associated with a second illumination pattern.

6. The method of claim 1, further comprising:
causing the optical system to increase a number of illumination patterns included among the multiple illumination patterns projected towards the scene, wherein a spatial density of the depth data for the scene is increased proportional to the increased number of illumination patterns.

7. The method of claim 1, wherein the multiple illumination patterns include a first illumination pattern and a second illumination pattern formed by spatially shifting each pattern element of the first illumination pattern by a pre-defined spatial offset.

8. The method of claim 1, wherein the multiple illumination patterns include a pair of complementary illumination patterns comprising a first illumination pattern and a second illumination pattern defining a logical negative of the first illumination pattern.

9. The method of claim 1, wherein the multiple illumination patterns have a common radiant power distributed among a different number of pattern elements.

10. The method of claim 1, wherein each illumination pattern among the multiple illumination patterns has a different temporal signature.

11. The method of claim 1, further comprising:
updating the depth data for the scene at a rate that is inversely proportional to a number of illumination patterns included among the multiple illumination patterns.

12. The method of claim 1, wherein the change in light intensity that exceeds the comparator threshold occurs when there is an increase or decrease in light intensity of a magnitude that exceeds the comparator threshold.

13. A method comprising:
acquiring pixel events output by an event sensor, each respective pixel event generated in response to a specific pixel within a pixel array of the event sensor detecting a change in light intensity that exceeds a comparator threshold, the pixel events corresponding to a scene disposed within a field of view of the event sensor;
generating mapping data by correlating the pixel events with a temporal signature projected by an optical system; and
determining depth data for the scene relative to a reference position based on the mapping data.

14. The method of claim 13, further comprising:
filtering the pixel events prior to generating the mapping data to exclude a subset of the pixel events lacking the temporal signature projected by the optical system.

15. The method of claim 13, wherein the reference position is defined based on: an orientation of the optical system relative to the event sensor, a location of the optical system relative to the event sensor, or a combination thereof.

16. The method of claim 13, wherein generating the mapping data comprises:
evaluating the pixel events to identify successive pixels events having a common polarity that are also associated with a common pixel sensor address.

17. The method of claim 16, wherein generating the mapping data further comprises:
determining the temporal signature by comparing time stamp information corresponding to the successive pixel events.

18. The method of claim 13, wherein the optical system projects multiple temporal signatures.

19. A system comprising
an electronic device with a processor; and
a computer-readable storage medium comprising instructions that upon execution by the processor cause the system to perform operations, the operations comprising:
acquiring, at the electronic device, pixel events output by an event sensor, each respective pixel event generated in response to a specific pixel sensor within a pixel array of the event sensor detecting a change in light intensity that exceeds a comparator threshold, the pixel events corresponding to a scene disposed within a field of view of the event sensor;
generating mapping data, at the electronic device, by correlating the pixel events with multiple illumination patterns projected by an optical system towards the scene, wherein the multiple illumination patterns are time-multiplexed; and
determining depth data, at the electronic device, for the scene relative to a reference position based on the mapping data.

20. The system of claim 19, further comprising the event sensor and the optical system.
